(19) United States
(12) Patent Application Publication
(10) Pub. No.: US 2025/0086539 A1
(43) Pub. Date: Mar. 13, 2025

(54) SUPPORT DEVICE, SUPPORT METHOD, AND STORAGE MEDIUM

(71) Applicant: KABUSHIKI KAISHA TOSHIBA, Tokyo (JP)

(72) Inventors: Yusuke AOKI, Yokohama Kanagawa (JP); Hiroshi SAKAI, Kawasaki Kanagawa (JP); Yuki SAKURAI, Yokohama Kanagawa (JP); Yasuo NAMIOKA, Nerima Tokyo (JP)

(21) Appl. No.: 18/827,031

(22) Filed: Sep. 6, 2024

(30) Foreign Application Priority Data
Sep. 11, 2023 (JP) 2023-147134

(51) Int. Cl. G06Q 10/0631

(52) U.S. Cl. CPC G06Q 10/063114

(57) ABSTRACT

According to an embodiment, a support device is configured to output a first work instruction and a safety instruction when a first worker performs a first task. The support device is further configured to output the first work instruction and not output the safety instruction, or output the first work instruction and output another safety instruction, when a second worker performs the first task.

### CROSS-REFERENCE TO RELATED APPLICATIONS

This application is based upon and claims the benefit of priority from Japanese Patent Application No. 2023-147134, filed on Sep. 11, 2023; the entire contents of which are incorporated herein by reference.

### FIELD

Embodiments described herein relate generally to a support device, a support method, and a storage medium.

### BACKGROUND

It is favorable for a worker to be safer when working.

### BRIEF DESCRIPTION OF THE DRAWINGS

FIG. 1 is a schematic view showing a support system according to an embodiment;

FIGS. 2A and 2B are schematic views showing output examples of the support device according to the embodiment;

FIGS. 3A and 3B are schematic views showing output examples of the support device according to the embodiment;

FIG. 4 is an example of work instruction data;

FIG. 5 is an example of safety instruction data;

FIG. 6 shows an example of ontologies;

FIG. 7 shows an example of ontologies;

FIG. 8 is a schematic view illustrating a user interface by the support device according to the embodiment;

FIG. 9 is a schematic view illustrating a user interface by the support device according to the embodiment;

FIG. 10 shows an example of a spatial model;

FIG. 11 is an example of an image acquired by an imaging device;

FIG. 12A is an example of a detection result, and FIG. 12B is an example of circumstance data;

FIG. 13 is a table illustrating a hazard detection model;

FIG. 14A is an example of safety instruction data, and FIG. 14B is an example of the safety instruction data after the revision;

FIG. 15 is a schematic view illustrating a user interface according to the support device according to the embodiment;

FIG. 16 is a schematic view illustrating a user interface according to the support device according to the embodiment;

FIG. 17 is a schematic view illustrating a user interface according to the support device according to the embodiment;

FIG. 18 is a flowchart showing a support method according to the embodiment; and

FIG. 19 is a schematic view illustrating a hardware configuration.

### DETAILED DESCRIPTION

According to an embodiment, a support device is configured to output a first work instruction and a safety instruction when a first worker performs a first task. The support device is further configured to output the first work instruction and not output the safety instruction, or output the first work instruction and output another safety instruction, when a second worker performs the first task.

Embodiments of the invention will now be described with reference to the drawings. In the drawings and the specification of the application, components similar to those described thereinabove are marked with like reference numerals, and a detailed description is omitted as appropriate.

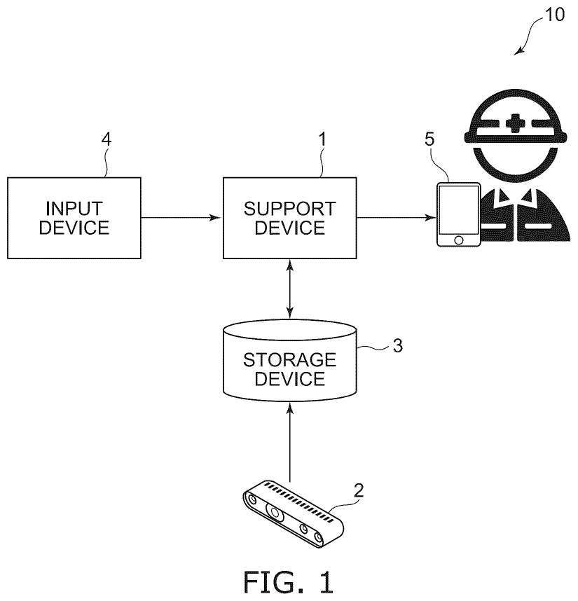

FIG. 1 is a schematic view showing a support system according to an embodiment.

As shown in FIG. 1, the support system 10 according to the embodiment includes a support device 1, an imaging device 2, a storage device 3, an input device 4, and an output device 5.

The support device 1 processes or manages data related to a task. For example, the support device 1 transmits a work instruction and a safety instruction to the output device 5. The work instruction is a specific and standard instruction related to a specific task. By checking the work instruction, the worker can ascertain how to best proceed with the task. The safety instruction includes instructions to be given attention when performing the task from the perspective of safety. For example, the safety instruction includes how to use an article used in the task.

The imaging device 2 acquires an image by imaging the appearance of the task. The imaging device 2 may acquire a video image. In such a case, a still image is cut out from the video image. The image that is acquired by the imaging device 2 is stored in the storage device 3. For example, the imaging device 2 is a camera that acquires an RGB image. Favorably, the imaging device 2 is an RGB-D camera that acquires depth information in addition to color information. The support device 1 detects a worker, an article, etc., from the image. The article is a product, a tool used in the task, etc. The product may be a finished product, or a semifinished product, a component, etc.

The user uses the input device 4 to input data to the support device 1. The output device 5 outputs an instruction or information toward the worker. A keyboard, a mouse, a touchpad, etc., can be used as the input device 4. A monitor, a speaker, a headphone, etc., can be used as the output device 5. The worker may carry a smart device that includes the functions of the input device 4 and the output device 5. The smart device is a smartphone, a tablet, a smartwatch, smart glasses, etc.

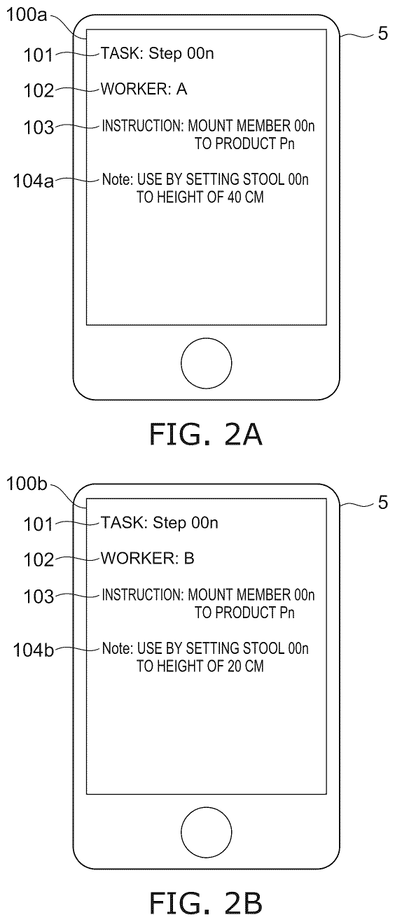

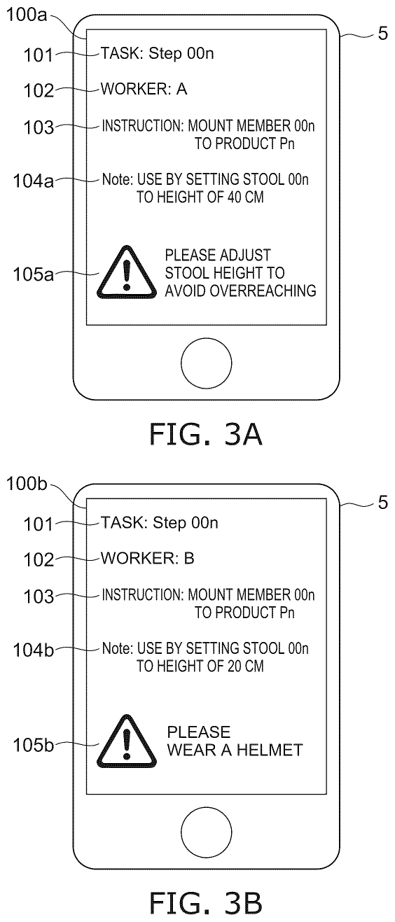

FIG. 2A, FIG. 2B, FIG. 3A, and FIG. 3B are schematic views showing output examples of the support device according to the embodiment.

For example, the support device 1 causes the output device 5 to display a user interface (UI) 100a shown in FIG. 2A. The UI 100a includes a task name 101, a worker name 102, a work instruction 103, and a safety instruction 104a.

The task name 101 is a name indicating the task to be performed. A character string such as an ID or the like that indicates the task may be displayed as the task name 101. The worker name 102 is the name of a person performing the task. A character string such as an ID or the like that indicates the worker may be displayed as the worker name 102.

The work instruction 103 includes an instruction of how to proceed with the task designated by the task name 101. The safety instruction 104a includes instructions for a worker A to safely perform the task designated by the task name 101. In the illustrated example, the worker A is instructed to use a stool set to a height of 40 cm when performing the task of step “00n”.

The support device 1 causes the output device 5 to display a UI 100b shown in FIG. 2B to another worker. Instead of the safety instruction 104a, the UI 100b includes a safety instruction 104b. The content of the safety instruction 104b is different from the content of the safety instruction 104a. In the illustrated example, a worker B is instructed to use a stool set to a height of 20 cm when performing the task of step “00n”. In other words, the height of the stool instructed to the worker B is different from the height of the stool instructed to the worker A. When the worker B does not need a stool in the task, a safety instruction related to a stool may not be displayed.

When the task is performed as shown in FIG. 2A and FIG. 2B, the support device 1 outputs common work instructions regardless of the worker. On the other hand, when the task is performed, the support device 1 outputs individual safety instructions to each worker. A safety instruction may not be output to some of the workers.

Furthermore, the support device 1 detects a hazard in the task from an image acquired by the imaging device 2. When the hazard is detected, the support device 1 outputs a warning regardless of the worker. In the example shown in FIG. 3A, the UI 100a displays a warning 105a. The warning 105a instructs a worker that is overreaching to adjust the height of the stool so that overreaching is unnecessary. In the example shown in FIG. 3B, the UI 100b displays a warning 105b. The warning 105b cautions the worker to wear a helmet.

The output from the support device 1 may be displayed as illustrated, or may be transmitted to the worker by a voice, vibration, light, etc. For example, the output device 5 reads aloud the safety instruction so that the worker can hear. The output device 5 may emit a vibration or light indicating the safety instruction. Different transmission techniques of the safety instruction may be used according to the characteristics of the worker. For example, it is favorable to output the safety instruction with a voice when the worker has poor vision such as presbyopia, myopia, amblyopia, etc.

The safety instruction may be output using multiple transmission methods. For example, the safety instruction may be displayed in the output device 5 and read aloud by the output device 5. In such a case, the display and reading aloud of the safety instruction may be performed by one output device 5, or the output device 5 that displays the safety instruction may be different from the output device 5 that reads aloud the safety instruction. By outputting the safety instruction by using multiple transmission techniques, the safety instruction can be more reliably transmitted to the worker.

Details of processing necessary for the support device 1 to output the work instruction, the safety instruction, and the warning will now be described.

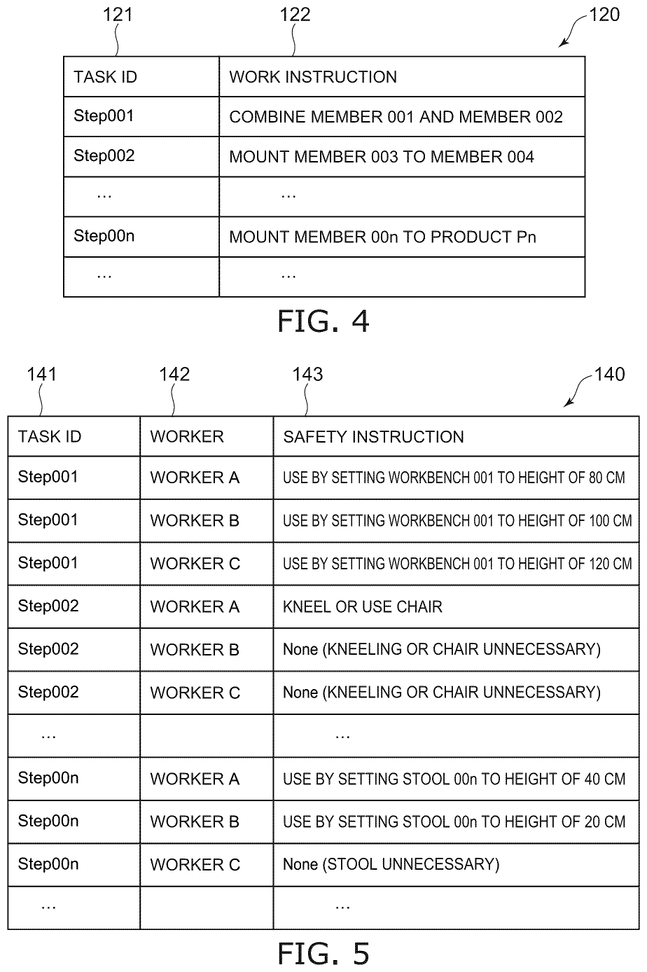

FIG. 4 is an example of work instruction data. FIG. 5 is an example of safety instruction data.

The support device 1 outputs the work instructions based on the work instruction data. For example, as shown in FIG. 4, work instruction data 120 includes a task name 121 and a work instruction 122. The content of the work instruction is registered in the work instruction 122 for each task name 121.

Also, the support device 1 outputs the safety instructions based on the safety instruction data. As shown in FIG. 5, safety instruction data 140 includes a task name 141, a worker name 142, and a safety instruction 143. The worker that may perform each task is registered in the worker name 142. The safety instruction 143 registers the content of the safety instruction for each worker. The work instruction and the safety instruction are not limited to the examples shown in FIG. 4 and FIG. 5; the work instruction and the safety instruction may be grouped in one table.

The hazard is detected based on an image from the imaging device 2, a spatial model, and a hazard detection model. The spatial model defines the position of the worker in the image, the skeleton of the worker, the clothing of the worker, the positions of articles related to the task, the operation statuses of machines, etc. Circumstance data includes data calculated from the image for items defined by the spatial model. The hazard detection model defines conditions for detecting hazards, etc.

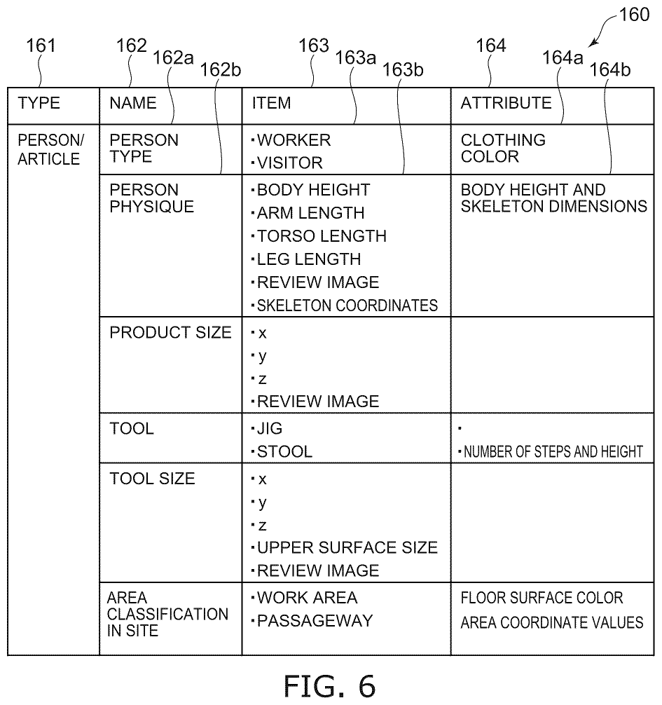

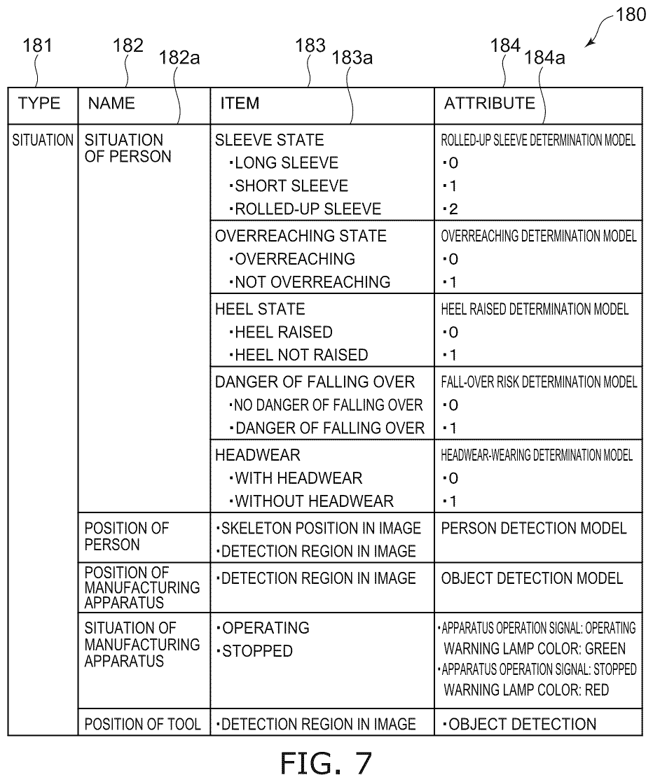

FIG. 6 and FIG. 7 show examples of ontologies.

The content that is defined in the spatial model and the hazard detection model is pre-grouped in ontologies by the user. The user is the manager of the support system 10, a person or worker operating the support device 1, etc.

For example, as shown in FIG. 6, an ontology 160 for the spatial model includes a type 161, a name 162, an item 163, and an attribute 164. The name 162 and the item 163 indicate specific content to be defined. The name 162 indicates a large classification. The item 163 shows specific content to be defined. The attribute 164 indicates specific values of the content designated by the name 162 and the item 163.

As an example, an item 163a of a name 162a includes “worker” and “visitor”. The color of the clothing worn by each of the worker and the visitor is defined in an attribute 164a. An item 163b of a name 162b includes “body height”, “arm length”, “leg length”, “torso length”, “review image”, and “skeleton coordinate”. Specific numerical values or filenames of each of the contents defined in the item 163b are defined in an attribute 164b.

As shown in FIG. 7, similarly to the ontology 160, an ontology 180 for the hazard detection model also includes a type 181, a name 182, an item 183, and an attribute 184. The name 182 and the item 183 indicate specific content to be defined. The attribute 184 indicates specific values of the content designated by the name 182 and the item 183. As an example, an item 183a of a name 182a includes “long sleeve”, “short sleeve”, and “rolled-up sleeve” as “sleeve state”. An attribute 184a shows that the sleeve state is determined by a rolled-up sleeve determination model; and values respectively of long sleeve, short sleeve, and rolled-up sleeve are defined.

The user generates the spatial model and the hazard detection model according to the pre-generated ontologies. The support device 1 may display a UI for generating the spatial model and the hazard detection model.

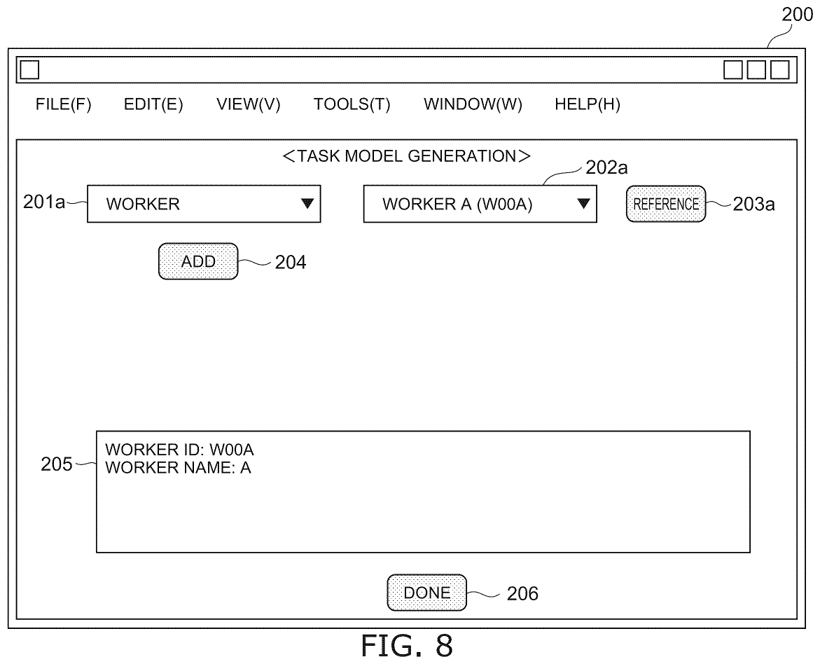

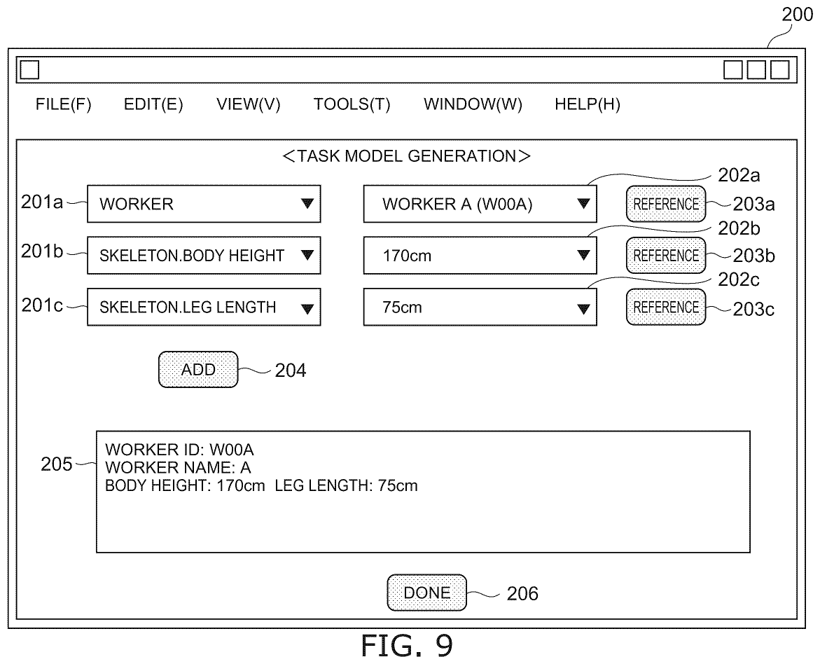

FIG. 8 and FIG. 9 are schematic views illustrating a user interface by the support device according to the embodiment.

For example, as shown in FIG. 8, the support device 1 displays a UI 200 (a first user interface) for the user to edit the spatial model. The UI 200 may be displayed by the output device 5 or may be displayed by another output device (monitor). The support device 1 accepts the input of the data from the user via the UI 200. The user can generate the spatial model by using the UI 200.

An input field 201a, an input field 202a, an icon 203a, an icon 204, a verification field 205, and an icon 206 are displayed in the UI 200. An item (a first item) of the data defined in the input field 202a is input in the input field 201a. For example, the user can select the content of the item from a pull-down menu. The content of the name 162 or the item 163 defined in the ontology 160 is listed as alternatives in the pull-down menu. After inputting in the input field 201a, the user inputs a specific value (attribute) of the selected item in the input field 202a.

In the illustrated example, “worker” is selected as an item in the input field 201a. The name and ID of the worker are input in the input field 202a.

The support device 1 may calculate the value input in the input field 202a from an image. For example, the user can click the icon 203a and select an image file. The support device 1 detects and designates the worker in the selected image. The support device 1 inputs the name and ID of the designated worker in the input field 202a. The content that is input is displayed in the verification field 205.

The user clicks the icon 204 when adding data defined by the spatial model. By clicking the icon 204, a new input field is displayed as shown in FIG. 9. The user inputs data in the new input field as well.

In the illustrated example, “body height” and “leg length” are selected respectively in input fields 201b and 201c. The body height and the leg length are input respectively in input fields 202b and 202c. The user may click an icon 203b or 203c and select an image file of the worker. The support device 1 calculates the body height or the leg length from the image. For example, the support device 1 detects the skeleton of the worker from the image. A pose estimation model can be used to detect the skeleton. OpenPose, DarkPose, CenterNet, etc., can be used as the pose estimation model. The body height, lengths of body parts, etc., are calculated from the detected skeleton by the support device 1 and input by the support device 1 in the input fields 202b and 202c.

When the input necessary for the spatial model is completed, the user clicks the icon 206. The support device 1 generates a spatial model corresponding to the input data in response to the click of the icon 206. The support device 1 stores the generated spatial model in the storage device 3.

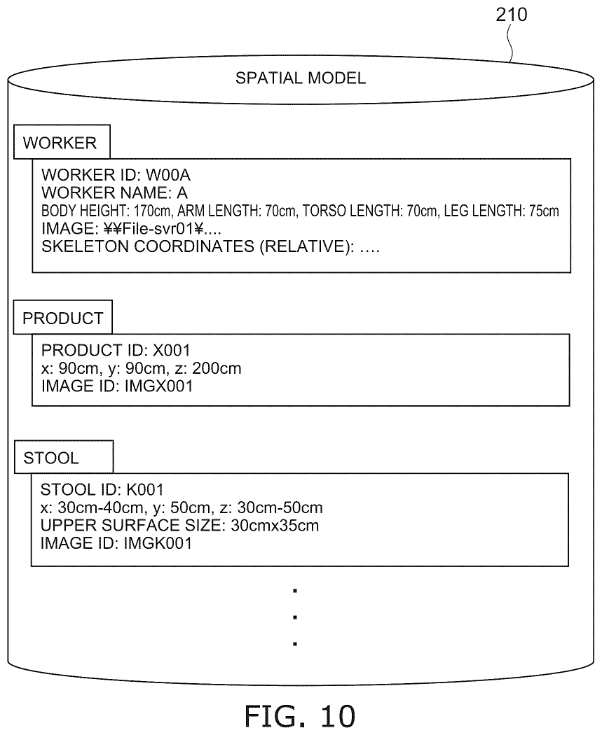

FIG. 10 shows an example of a spatial model.

The user generates the spatial model by repeating the input to the UI 200. FIG. 10 is an example of the generated spatial model. The spatial model 210 shown in FIG. 10 defines data related to the worker, data related to the product which is the task object, data related to tools (the stool) used in the task, etc.

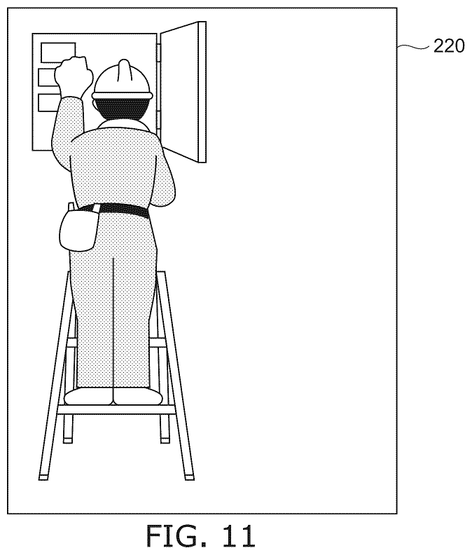

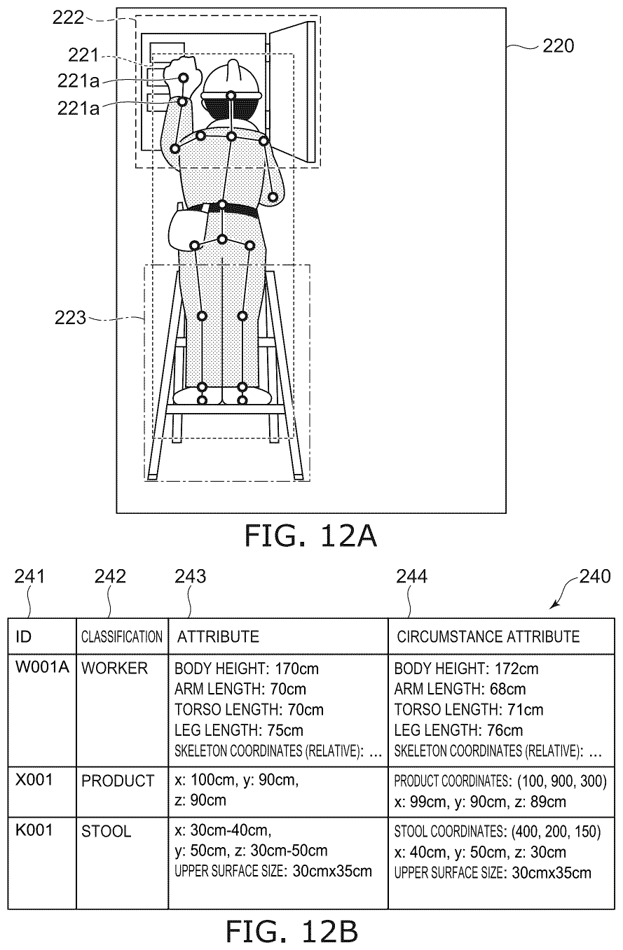

FIG. 11 is an example of an image acquired by an imaging device. FIG. 12A is an example of a detection result. FIG. 12B is an example of circumstance data.

When the image that is imaged by the imaging device 2 is acquired, the support device 1 generates circumstance data based on the image and the spatial model. For example, the support device 1 acquires an image 220 shown in FIG. 11. In the image 220, the worker is using a stool to work. The support device 1 inputs the image 220 to a pose estimation model and detects the person and the skeleton of the person in the image 220. The support device 1 determines that the detected person is a worker defined by the spatial model. Also, from the image 220, the support device 1 detects products, tools, etc., at positions defined by the spatial model.

Based on the spatial model shown in FIG. 10, the support device 1 detects a worker 221, a product 222, and a stool 223 from the image 220 as shown in FIG. 12A. The support device 1 uses pose detection to detect a skeleton 221a of the worker 221. Also, the support device 1 uses depth information included in the image to calculate the physique of the worker 221, dimensions of the product 222, and dimensions of the stool 223. The physique of the worker 221 is calculated based on the skeleton 221a. For example, the body height corresponds to the length from the top of the foot to the head. The leg length corresponds to the length from the top of the foot to the pelvis.

As shown in FIG. 12B, the support device 1 acquires the result calculated from the image as circumstance data 240. The circumstance data 240 includes an ID 241, a classification 242, an attribute 243, and a circumstance attribute 244. The ID 241 is the ID of all objects (including workers) detected from the image. The classification 242 is the classification of the ID 241. The attribute 243 is the attribute of each item in the spatial model. The circumstance attribute 244 is the attribute calculated from the image for each item in the spatial model.

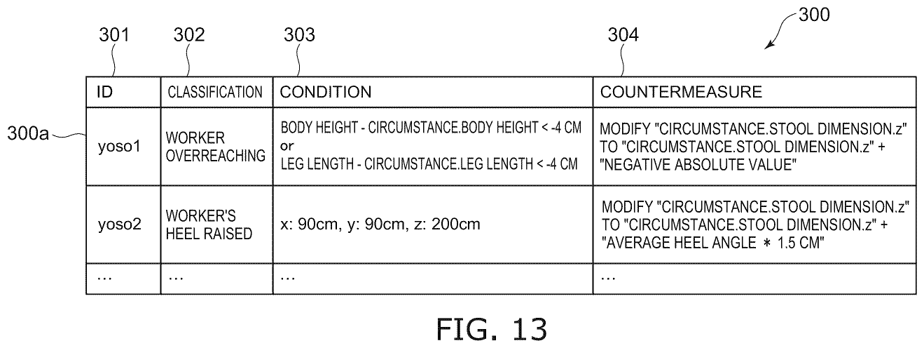

FIG. 13 is a table illustrating a hazard detection model.

The support device 1 detects a hazard by comparing the circumstance data to the hazard detection model. When detecting a hazard, the support device 1 outputs a warning. For example, as shown in FIG. 13, the hazard detection model 300 includes a model ID 301, a classification 302, and a condition 303. The model ID 301 is a character string for identifying the hazard detection model. The classification 302 is the classification of the hazard detection model. In the illustrated example, the classification 302 indicates what kind of state is detected as a hazard in each hazard detection model. The condition 303 is the condition of detecting the hazard. The condition 303 is described using an attribute of an item defined by the spatial model.

In the illustrated example, a hazard detection model 300a detects overreaching by the worker as a hazard. When working by overreaching, the center of gravity becomes unstable, and there is a danger that the worker may fall over. Also, there is a possibility that an excessive load may be applied to a specific location of the body, and the body may be hurt. When the worker is overreaching, the body height of the worker calculated from the image exceeds the predefined body height. Therefore, the hazard detection model 300a determines a hazard (overreaching) based on the difference between the body height predefined by the spatial model and the body height in the circumstance data.

In the illustrated example, when the value of the calculated body height subtracted from the defined body height is less than −4 cm, the worker is determined to be overreaching. When a hazard is detected using the circumstance data and the hazard detection model, the support device 1 outputs a warning to prompt safer work as shown in FIG. 3A or FIG. 3B.

As shown in FIG. 13, the hazard detection model 300 may include a countermeasure 304. The countermeasure 304 includes revising the safety instruction when the hazard is detected. For example, when overreaching is detected, the countermeasure 304 included in the hazard detection model 300a revises the safety instruction for the worker A for the task being performed. The stool height presented to the worker A is increased by the countermeasure 304 of the hazard detection model 300a. The next time the worker A performs the task, the revised safety instruction is output.

The spatial model and the hazard detection model are generated for each work site. The storage device 3 stores which of the tasks are performed in which of the work sites. When the worker performs some task, the support device 1 references the work site associated with the task and acquires the spatial model and the hazard detection model associated with the work site. The support device 1 calculates the circumstance data by using an image from the imaging device 2 and the acquired spatial model. The support device 1 detects the hazard by using the circumstance data and the acquired hazard detection model.

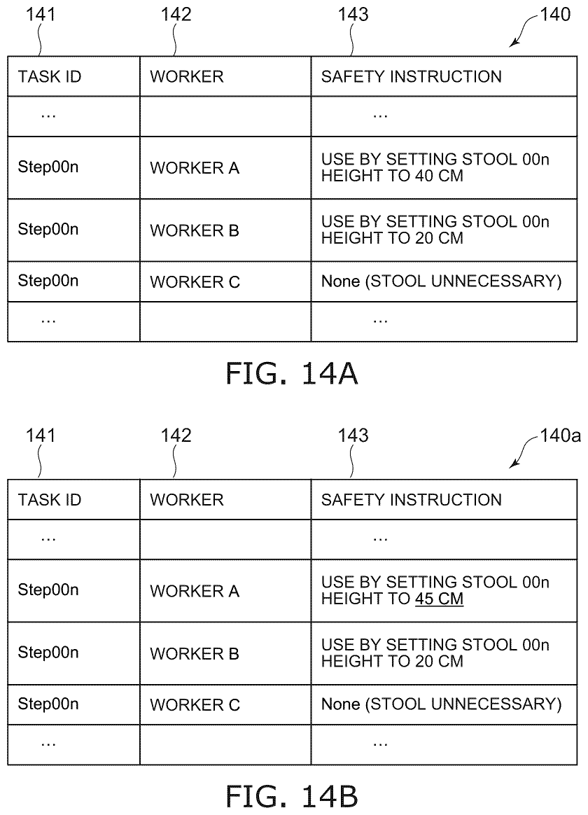

FIG. 14A is an example of safety instruction data. FIG. 14B is an example of the safety instruction data after the revision.

FIG. 14A shows the same safety instruction data 140 as FIG. 5A. For example, a hazard is detected by the hazard detection model 300a shown in FIG. 13, and the countermeasure 304 is performed. The worker A is determined to be overreaching by 5 cm. In such a case, as in safety instruction data 140a shown in FIG. 14B, the stool height in the safety instruction to the worker A for the task “step00 n” is revised from “40 cm” to “45 cm”. Thereafter, the safety instruction is output to the worker A to set the stool height to 45 cm.

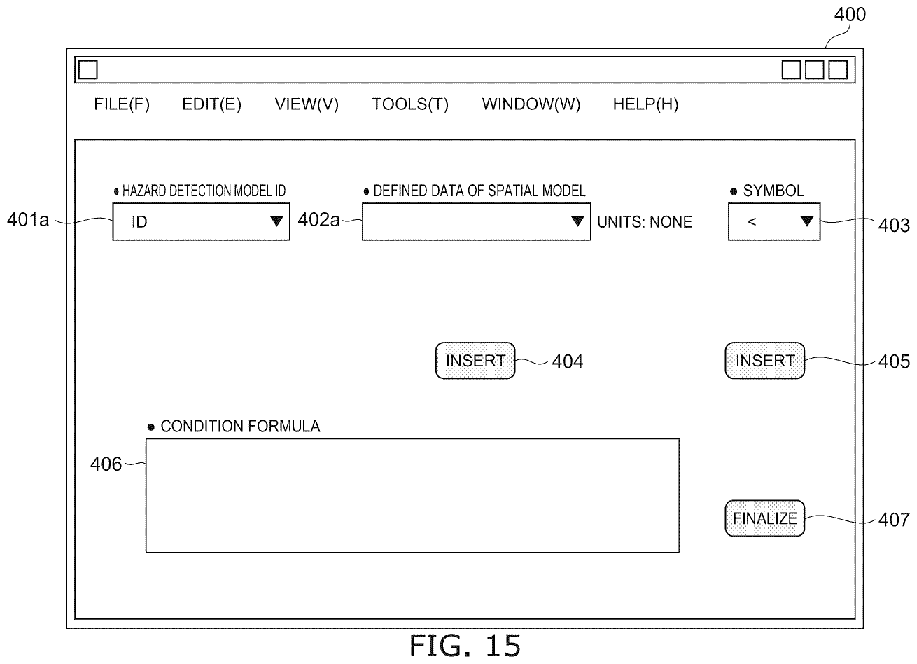

FIG. 15 to FIG. 17 are schematic views illustrating a user interface according to the support device according to the embodiment.

As shown in FIG. 15, for example, the support device 1 may display a UI 400 (a second user interface) for the user to edit the hazard detection model. The support device 1 accepts input of data from the user via the UI 400. The user can generate a hazard detection model by using the UI 400.

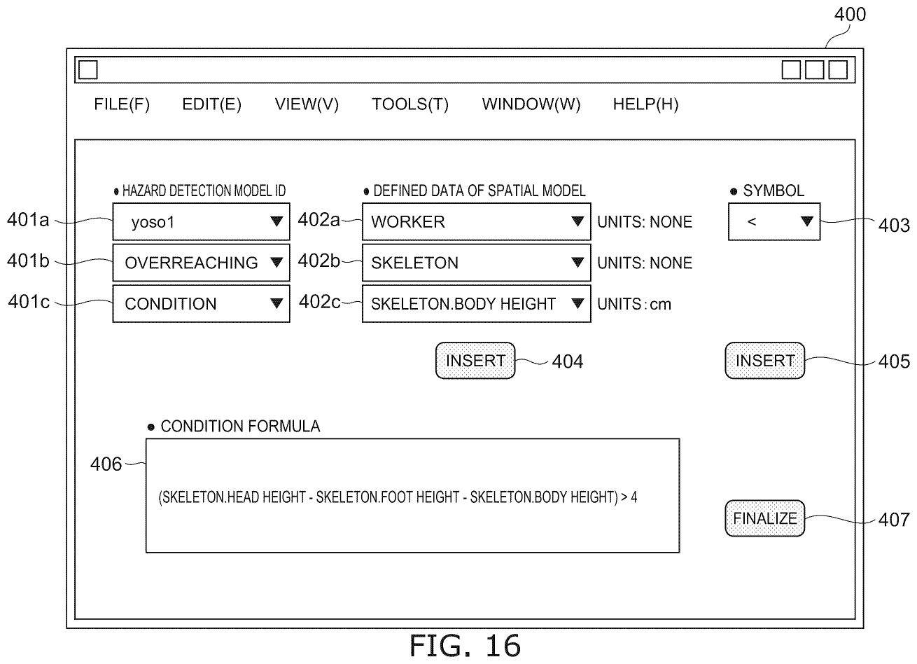

The UI 400 displays an input field 401a, an input field 402a, an icon 404, an icon 405, an input field 406, and an icon 407. The ID of the hazard detection model is input in the input field 401a. As shown in FIG. 16, an input field 401c and the input field 402a are displayed when a character string is input in the input field 401a. The input field 401c indicates that the input field 402a is related to a setting of a condition.

The item of the data referenced in the predefined spatial data is designated in the input field 402a. An input field 402b is displayed when data is input in the input field 402a. An item that is more specific than the input field 402a is input in the input field 402b. An input field 402c is displayed when data is input in the input field 402b. An item that is more specific than the input field 402a is input in the input field 402b. The user can select the referenced items from pull-down menus when inputting the data in the input fields 402a to 402c.

In the illustrated example, the ID of the newly-generated hazard detection model is defined as “yoso1”. The classification of the hazard detection model is defined as “overreaching”. The “body height” calculated from the “skeleton” of the “worker” is defined to be referenced as the condition of the hazard detection model.

When the data used for the condition is designated by the input fields 402a to 402c, the user clicks the icon 404. As a result, the designated data is inserted into the input field 406. The user also can input, in an input field 403, a mathematical symbol used in the input field 406. The mathematical symbol can be selected from a pull-down menu. When inputting a symbol in the input field 403, the user clicks the icon 405. As a result, the symbol that is input is inserted into the input field 406.

The user generates a condition formula as shown in FIG. 16 by repeating the input of the data in the input fields 402a to 402c, the input of the symbol in the input field 403, the insertion of data or symbols in the input field 406, etc. When the input of the condition formula is completed, the user clicks the icon 407.

In response to the click of the icon 407, the support device 1 registers the data input to the UI 400 as the hazard detection model. According to the illustrated hazard detection model “yoso1”, “overreaching” is detected when the difference between the predefined body height and the height from the head to the foot in the detected skeleton is greater than 4 cm.

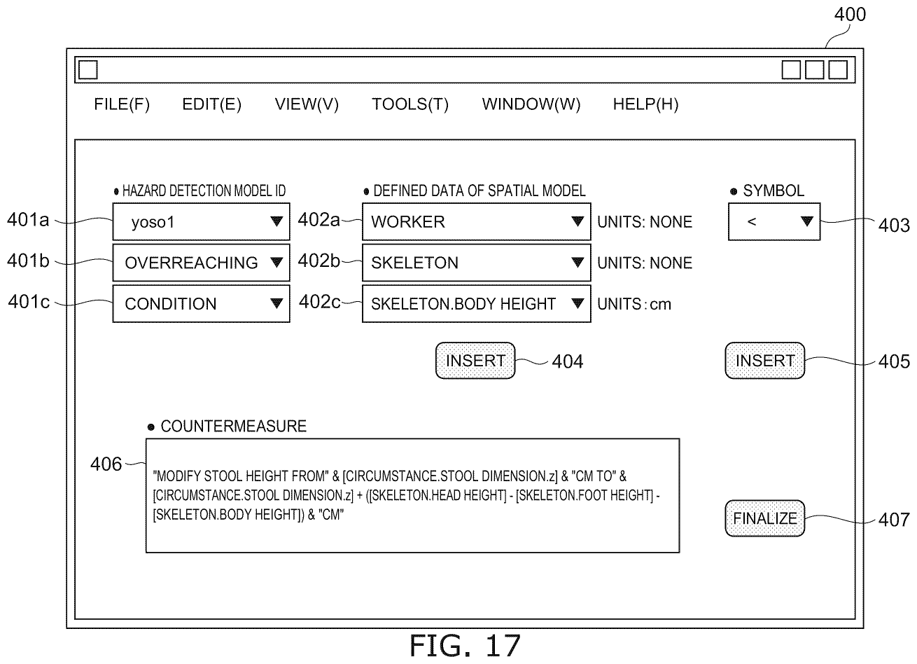

The user also can set a countermeasure of the hazard detection model via the UI 400. As shown in FIG. 17, the condition or the countermeasure can be selected using the pull-down menu in the input field 401c. When the countermeasure is input, the user inputs content displayed as the countermeasure in the input field 406.

As an example, the character strings that are directly displayed are marked with quotation marks. Also, the user can designate variables by inputting data in the input fields 402a to 402c. When the countermeasure is displayed, the specific values are referenced as the designated variables, and the values are displayed. The character strings and the data are connected by “&”.

The user clicks the icon 407 when the input of the countermeasure is completed. In response to the click of the icon 407, the support device 1 associates the countermeasure input to the UI 400 with the hazard detection model having the input ID. According to the illustrated example, the countermeasure is displayed so that the stool height is modified to a value of the overreached height added to the preregistered height stool height.

Other than overreaching, the support device 1 may detect whether or not the worker has a rolled-up sleeve, whether or not the worker is wearing headwear, whether or not there is a danger of falling over, etc. For example, a rolled-up sleeve or an uncovered head is detected by inputting an image of the worker to a model for detecting a rolled-up sleeve or a model for detecting an uncovered head. To increase the accuracy of the detection, it is favorable for the model to include a neural network. Favorably, the neural network is a convolutional neural network (CNN). The model is subjected to supervised learning beforehand by using training data. The training data includes images of the worker and labels of the images. The labels indicate whether or not the worker that is imaged in the image has a rolled-up sleeve or is wearing headwear.

The danger of falling over is detected based on the skeleton of the worker. The support device 1 calculates the position of the center of gravity of each skeleton of the worker. Also, the support device 1 calculates the position of the left foot and the position of the right foot of the worker. The danger of falling over can be detected based on the center of gravity and the positions of the left and right feet. For example, it is determined that there is no danger of falling over when the position of the center of gravity with respect to the direction connecting the left and right feet is between the position of the left foot and the position of the right foot. It is determined that there is a danger of falling over when the position of the center of gravity is outside the range between the position of the left foot and the position of the right foot.

The safety instruction may include a setting instruction of lighting in addition to the pose, tool usage, and clothing described above. For example, the appropriate illuminance increases with age. The safety instruction includes a setting instruction of the appropriate illuminance for each worker. In such a case, a radiometer is located in the work site. The illuminance being less than a preset threshold is defined by the hazard model. When the measured illuminance is less than the threshold, the support device 1 outputs a warning prompting an adjustment of the lighting. For example, the worker illuminates the task object more brightly by increasing the illuminance. Or, the worker may illuminate the task object more brightly by adjusting the position and orientation of the lighting.

The safety instruction may include a setting instruction of the color temperature of the lighting. For example, a visually impaired person has difficulty seeing specific colors. Therefore, there are cases where objects are made easier to view by changing the color temperature. The safety instruction includes a setting instruction of the appropriate color temperature for each worker. In such a case, a color illuminance meter is located in the work site. The hue and the color saturation being outside preset ranges is defined by the hazard model. When the measured hue and color saturation are outside the preset ranges, the support device 1 outputs a warning prompting an adjustment of the color temperature.

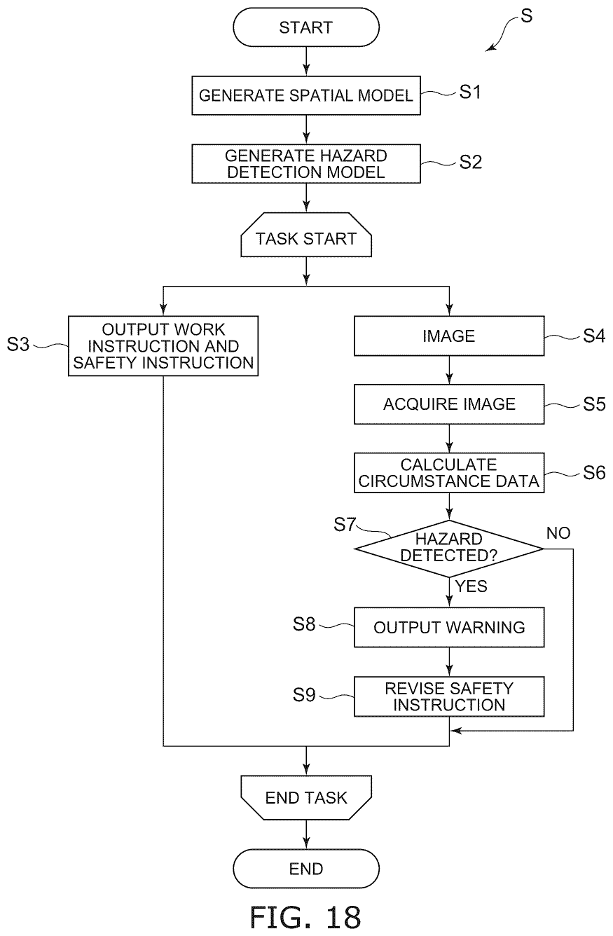

FIG. 18 is a flowchart showing a support method according to the embodiment.

In the support method S according to the embodiment, first, the user generates a spatial model and a hazard detection model (steps S1 and S2). Subsequently, the task is started. The support device 1 outputs a work instruction and a safety instruction corresponding to the task being performed (step S3). Also, the imaging device 2 images the appearance of the task (step S4). The support device 1 acquires the image that is imaged (step S5). The support device 1 calculates circumstance data by using the image and the spatial model (step S6). The support device 1 detects a hazard by using the circumstance data and the hazard detection model (step S7). When a hazard is detected, the support device 1 outputs a warning (step S8). The support device 1 revises the safety instruction for each worker according to the detected hazard (step S9). Steps S3 to S9 are repeated until the task ends.

Advantages of the embodiment will now be described.

According to a conventional method, a work instruction is output toward the worker when the worker performs a task. The work instruction indicates a standard work procedure. The work instruction is pre-generated for each task regardless of the worker. Even when the worker has limited experience or knowledge, the worker can smoothly perform the task by following the work instruction. Also, the work instruction is established so that many workers can safely perform the task. By following the work instruction, the worker can proceed with the task without much danger.

When performing the task, the worker follows the work instruction and behaves appropriately for the task. For example, the worker assumes a pose in which the task is easily performed. Because the physique is different for each worker, the pose suited to the task also is different for each worker. There is a possibility that worker safety or hygiene may be compromised by the pose. In other words, the work instruction is effective in avoiding serious danger. However, the work instruction does not consider the avoidance of minor danger.

For this problem, the support device 1 according to the embodiment outputs safety instructions for each worker in addition to the work instructions for each task. The safety instruction may be optimized for each worker. The worker can work more safely by behaving according to the safety instruction while performing the task according to the work instruction.

For example, according to the embodiment, the support device 1 outputs a first work instruction and a safety instruction when a first worker performs a first task. When a second worker that is different from the first worker performs the same first task, the support device 1 does not output a safety instruction while outputting the first work instruction. Or, the support device 1 outputs another safety instruction while outputting the first work instruction. When the safety instruction is output to the second worker, the safety instruction for the second worker is different from the safety instruction output to the first worker.

Furthermore, when a hazard is detected, the support device 1 outputs a warning. By outputting the warning in addition to the safety instruction, the worker can work more safely. Favorably, when the hazard is detected, the support device 1 revises the safety instruction according to the detected hazard. As a result, the danger during the next time the same task is performed can be reduced.

As shown in FIG. 8 or FIG. 15, the support device 1 can display a UI for editing the spatial model or the hazard detection model. The user can easily edit (generate or modify) the spatial model or the hazard detection model via the UI. Also, by pre-defining the items defined by each model as ontologies as shown in FIG. 6 and FIG. 7, even a user with limited knowledge can easily edit the models.

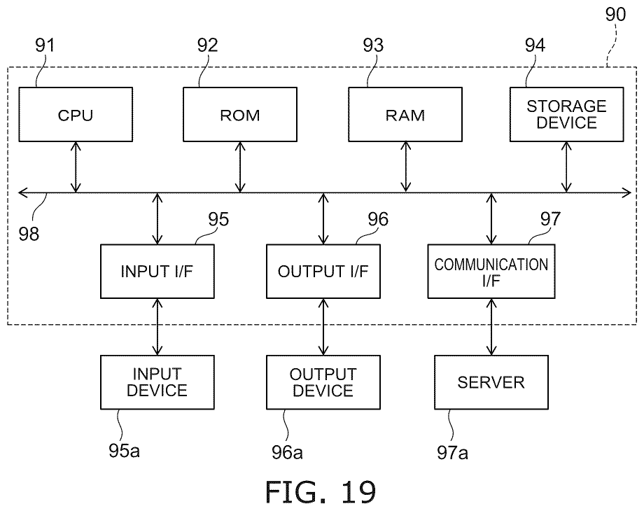

FIG. 19 is a schematic view illustrating a hardware configuration.

For example, a computer 90 shown in FIG. 19 is used as the support device 1. The computer 90 includes a CPU 91, ROM 92, RAM 93, a storage device 94, an input interface 95, an output interface 96, and a communication interface 97.

The ROM 92 stores programs controlling operations of the computer 90. Programs necessary for causing the computer 90 to realize the processing described above are stored in the ROM 92. The RAM 93 functions as a memory region into which the programs stored in the ROM 92 are loaded.

The CPU 91 includes a processing circuit. The CPU 91 uses the RAM 93 as work memory and executes the programs stored in at least one of the ROM 92 or the storage device 94. When executing the programs, the CPU 91 executes various processing by controlling configurations via a system bus 98.

The storage device 94 stores data necessary for executing the programs and/or data obtained by executing the programs.

The input interface (I/F) 95 can connect the computer 90 and an input device 95a. The input I/F 95 is, for example, a serial bus interface such as USB, etc. The CPU 91 can read various data from the input device 95a via the input I/F 95. The input device 95a may be used as the input device 4.

The output interface (I/F) 96 can connect the computer 90 and an output device 96a. The output I/F 96 is, for example, an image output interface such as Digital Visual Interface (DVI), High-Definition Multimedia Interface (HPMI (registered trademark)), etc. The CPU 91 can transmit data to the output device 96a via the output I/F 96 and can cause the output device 96a to display an image.

The communication interface (I/F) 97 can connect the computer 90 and a server 97a outside the computer 90. The communication I/F 97 is, for example, a network card such as a LAN card, etc. The CPU 91 can read various data from the server 97a via the communication I/F 97.

The storage device 94 is a hard disk drive (HDD), a solid state drive (SSD), a network HDD (NAS), etc. The input device 95a includes at least one selected from a mouse, a keyboard, a microphone (audio input), and a touchpad. The output device 96a includes at least one selected from a monitor, a projector, a printer, and a speaker. A device such as a touch panel that functions as both the input device 95a and the output device 96a may be used.

The processing according to the support device 1 may be realized by one computer 90, or may be realized by collaboration of multiple computers 90.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD±R, DVD±RW, etc.), semiconductor memory, or another non-transitory computer-readable storage medium (non-transitory computer-readable storage medium).

For example, the information that is recorded in the recording medium can be read by a computer (or an embedded system). The recording format (the storage format) of the recording medium is arbitrary. For example, the computer reads the program from the recording medium and causes a CPU to execute the instructions recited in the program based on the program. In the computer, the acquisition (or the reading) of the program may be performed via a network.

The embodiment of the invention includes the following features.

### (Feature 1)

A support device, configured to:
output a first work instruction and a safety instruction when a first worker performs a first task; and
when a second worker performs the first task, output the first work instruction and not output the safety instruction, or output the first work instruction and output another safety instruction.

### (Feature 2)

The support device according to feature 1, wherein
when a hazard is detected when the first task is being performed, a warning is output regardless of a worker performing the first task.

### (Feature 3)

The support device according to feature 2, wherein
a spatial model and an image are used to calculate an attribute related to an item in the image, the item being at least one item selected from a physique, a pose, and a center of gravity of the first worker, the item being defined in the spatial model, the first task being imaged in the image, and
the hazard is detected using the calculated attribute and a hazard detection model, a condition of the hazard being defined in the hazard detection model.

### (Feature 4)

The support device according to feature 3, wherein
an output device is caused to display a first user interface for editing the spatial model, and
in the first user interface, a first item can be selected, and an attribute of the selected first item can be accepted.

### (Feature 5)

The support device according to feature 3 or 4, wherein
an output device is caused to display a second user interface for editing the hazard detection model, and
in the second user interface, a second item can be selected, and an attribute of the selected second item can be accepted.

### (Feature 6)

The support device according to any one of features 2 to 5, wherein
the safety instruction is revised when the hazard is detected when the first worker is performing the first task.

### (Feature 7)

The support device according to feature 6, wherein
the revised safety instruction is output when the first worker is performing a next first task.

### (Feature 8)

A support method, comprising:
causing a computer to:
   output a first work instruction and a safety instruction when a first worker performs a first task; and
   when a second worker performs the first task, output the first work instruction and not output the safety instruction, or output the first work instruction and output another safety instruction.

### (Feature 9)

A storage medium storing a program,
the program causing a computer to execute the support method according to feature 8.

According to the support device or the support system described above, the worker can be supported to be able to work more safely. By causing a computer to perform the support method, the worker can be supported to be able to work more safely. Also, similar effects can be obtained by using a program that causes a computer to perform the support method.

While certain embodiments of the invention have been illustrated, these embodiments have been presented by way of example only, and are not intended to limit the scope of the inventions. These novel embodiments may be embodied in a variety of other forms; and various omissions, substitutions, modifications, etc., can be made without departing from the spirit of the inventions. These embodiments and their modifications are within the scope and spirit of the invention and are within the scope of the inventions described in the claims and their equivalents. Also, the embodiments described above can be implemented in combination with each other.

What is claimed is:

1. A support device, configured to:
output a first work instruction and a safety instruction when a first worker performs a first task; and
when a second worker performs the first task, output the first work instruction and not output the safety instruction, or output the first work instruction and output another safety instruction.

2. The support device according to claim 1, wherein
when a hazard is detected when the first task is being performed, a warning is output regardless of a worker performing the first task.

3. The support device according to claim 2, wherein
a spatial model and an image are used to calculate an attribute related to an item in the image, the item being at least one item selected from a physique, a pose, and a center of gravity of the first worker, the item being defined in the spatial model, the first task being imaged in the image, and
the hazard is detected using the calculated attribute and a hazard detection model, a condition of the hazard being defined in the hazard detection model.

4. The support device according to claim 3, wherein
an output device is caused to display a first user interface for editing the spatial model, and
in the first user interface, a first item can be selected, and an attribute of the selected first item can be accepted.

5. The support device according to claim 3, wherein
an output device is caused to display a second user interface for editing the hazard detection model, and
in the second user interface, a second item can be selected, and an attribute of the selected second item can be accepted.

6. The support device according to claim 2, wherein
the safety instruction is revised when the hazard is detected when the first worker is performing the first task.

7. The support device according to claim 6, wherein
the revised safety instruction is output when the first worker is performing a next first task.

8. A support method, comprising:
causing a computer to:
output a first work instruction and a safety instruction when a first worker performs a first task; and
when a second worker performs the first task, output the first work instruction and not output the safety instruction, or output the first work instruction and output another safety instruction.

9. A non-transitory computer-readable storage medium storing a program,
the program causing a computer to execute the support method according to claim 8.
